(19) United States
(12) Patent Application Publication
(10) Pub. No.: US 2021/0049820 A1
(43) Pub. Date: Feb. 18, 2021

(54) Mobile Augmented Reality Apparatus Using Edge Computing and Method For Energy-Efficient Resolution and Transmission Power Control Thereof

(71) Applicant: Korea Advanced Institute of Science and Technology, Daejeon (KR)

(72) Inventors: Jun Kyun Choi, Daejeon (KR); Jaewon Ahn, Daejeon (KR); Joohyung Lee, Daejeon (KR); Hong-Shik Park, Daejeon (KR)

(73) Assignee: Korea Advanced Institute of Science and Technology, Daejeon (KR)

(21) Appl. No.: 16/578,494

(22) Filed: Sep. 23, 2019

(30) Foreign Application Priority Data
Aug. 14, 2019 (KR) 10-2019-0099291

(51) Int. Cl. G06T 19/00; H04N 1/00; G06F 3/01; G06K 9/00; H04W 88/02; H04W 76/10

(52) U.S. Cl. CPC G06T 19/006; H04N 1/00127; H04W 76/10; G06K 9/00201; H04W 88/02; G06F 3/011

(57) ABSTRACT

An electronic device and an operating method thereof according to various embodiments relate to a mobile AR apparatus using edge computing and a method for energy-efficient resolution and transmission power control thereof. The device and method may be configured to capturing an image, determining a resolution and a transmission power that satisfy a maximum delay and minimum recognition accuracy necessary to recognize an object from the image, adjusting the captured image based on the determined resolution, and transmitting the adjusted image based on the determined transmission power.

### CROSS REFERENCE TO RELATED APPLICATION

This application is based on and claims priority under 35 U.S.C. 119 to Korean Patent Application No. 10-2019-0099291, filed on Aug. 14, 2019, in the Korean Intellectual Property Office, the disclosures of which is herein incorporated by reference in their entireties.

### BACKGROUND OF THE INVENTION

### 1. Technical Field

Various embodiments relate to an electronic device and an operating method thereof and, more particularly, to a mobile augmented reality (AR) apparatus using edge computing and a method for energy-efficient resolution and transmission power control thereof.

### 2. Description of the Related Art

With the development of the technology, an electronic device provides various services by performing various functions. Accordingly, the electronic device can provide augmented reality. Augmented reality is a technology for displaying virtual content by overlapping the virtual content and an actual environment. That is, a user can see virtual content overlapping an actual environment through the electronic device. To this end, the electronic device may capture an image of the actual environment and recognize an object from the image. Furthermore, the electronic device searches for content related to the object through an external server, and overlaps and displays the content and the actual environment.

However, such an electronic device has a problem in that it consumes a large amount of energy in recognizing an object from an image. Furthermore, such an electronic device has a problem in that delay according to communication occurs in searching for content related to an object through an external server. Such delay may further increase the amount of energy consumed of the electronic device. That is, energy resources for the electronic device are consumed inefficiently.

### SUMMARY OF THE INVENTION

Various embodiments provide an electronic device capable of efficiently managing energy resources and an operating method thereof.

Various embodiments provide an electronic device capable of minimizing the amount of energy consumed by the electronic device while securing recognition accuracy for an object to a given level and an operating method thereof.

According to various embodiments, an operating method of an electronic device may include capturing an image, determining a resolution and a transmission power satisfying a maximum delay and minimum recognition accuracy necessary to recognize an object from the image, adjusting the captured image based on the determined resolution, and transmitting the adjusted image based on the determined transmission power.

According to various embodiments, an electronic device may include a communication module for wireless communication, a camera module configured to capture an image, and a processor connected to the communication module and the camera module.

According to various embodiments, the processor may be configured to capture an image, determine a resolution and a transmission power satisfying a maximum delay and minimum recognition accuracy necessary to recognize an object from the image, adjust the captured image based on the determined resolution, and transmit the adjusted image based on the determined transmission power through the communication module.

### BRIEF DESCRIPTION OF THE DRAWINGS

FIG. 1 is a diagram illustrating a communication system according to various embodiments.

FIG. 2 is a diagram illustrating an operating method of the communication system according to various embodiments.

FIGS. 3, 4 and 5 are diagrams for illustrating operating characteristics of the communication system according to various embodiments.

FIG. 6 is a diagram illustrating an electronic device according to various embodiments.

FIG. 7 is a diagram illustrating a processor of FIG. 6.

FIG. 8 is a diagram illustrating an operating method of the electronic device according to various embodiments.

FIG. 9 is a diagram illustrating an operation of determining resolution and transmission power in FIG. 8.

### DETAILED DESCRIPTION

Hereinafter, various embodiments of this document are described with reference to the accompanying drawings.

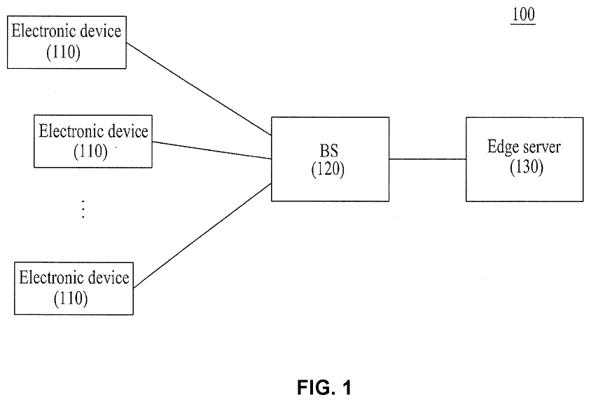

FIG. 1 is a diagram illustrating a communication system 100 according to various embodiments.

Referring to FIG. 1, the communication system 100 according to various embodiments may include at least any one of at least one electronic device 110, at least one base station (BS) 120 or an edge server.

The electronic device 110 may provide augmented reality (AR) for a user. In this case, the electronic device 110 may be worn on a user's face. For example, the electronic device 110 is a mobile AR apparatus, and may include at least any one of a head mount display (HMD) device or AR glasses. The electronic device 110 may display, on a background, content related to an object within the background. According to one embodiment, the background may be a reality background for an actual environment. For example, the electronic device 110 may display content related to an object so that the content passes through a reality background. According to another embodiment, the background may be a background image photographed from an actual environment. For example, the electronic device 110 may display content related to an object by overlapping the content on a background image. To this end, the electronic device 110 may capture an image of an actual environment.

The BS 120 may manage communication for the electronic device 110. In this case, the BS 120 may manage one electronic device 110 or may manage a plurality of electronic devices 110. The BS 120 may relay communication between the electronic device 110 and the edge server 130. In this case, the BS 120 may transmit an image, captured by the electronic device 110, to the edge server 130, and may transmit content related to an object from the edge server 130 to the electronic device 110.

The edge server 130 may process data related to the electronic device 110. In this case, the edge server 130 may include at least one database (DB) or may be connected to at least one DB. Accordingly, the edge server 130 may store data, received from the electronic device 110, in the DB or may provide the electronic device 110 data retrieved from the DB. In this case, the edge server 130 may recognize an object from an image captured by the electronic device 110, and may detect content related to the object. Accordingly, the edge server 130 can provide the electronic device 110 with the content related to the object.

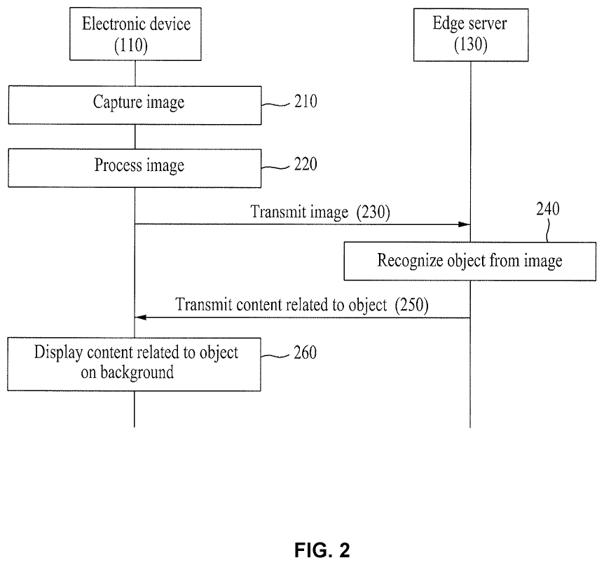

FIG. 2 is a diagram illustrating an operating method of the communication system 100 according to various embodiments.

Referring to FIG. 2, at operation 210, the electronic device 110 may capture an image. At operation 220, the electronic device 110 may process the image. At this time, the electronic device 110 may compress the image. To this end, the electronic device 110 may determine proper resolution and transmission power. That is, the electronic device 110 may adjust the image based on the determined resolution. At operation 230, the electronic device 110 may transmit the image to the edge server 130. The electronic device 110 may output the image based on the determined transmission power.

At operation 230, the edge server 130 may receive the image from the electronic device 110. In response to the reception, the edge server 130 may recognize an object from the image at operation 240. That is, the edge server 130 may analyze the image and detect the object within the image. At operation 250, the edge server 130 may transmit, to the electronic device 110, content related to the object. The edge server 130 may search the DB for the content related to the object, and may transmit the retrieved content to the electronic device 110.

At operation 250, the electronic device 110 may receive, from the edge server 130, the content related to the object. In response to the reception, the electronic device 110 may display the content related to the object on the background at operation 260. According to one embodiment, the electronic device 110 may display content related to an object so that the content passes through a reality background. According to another embodiment, the electronic device 110 may display content related to an object by overlapping the content on a background image.

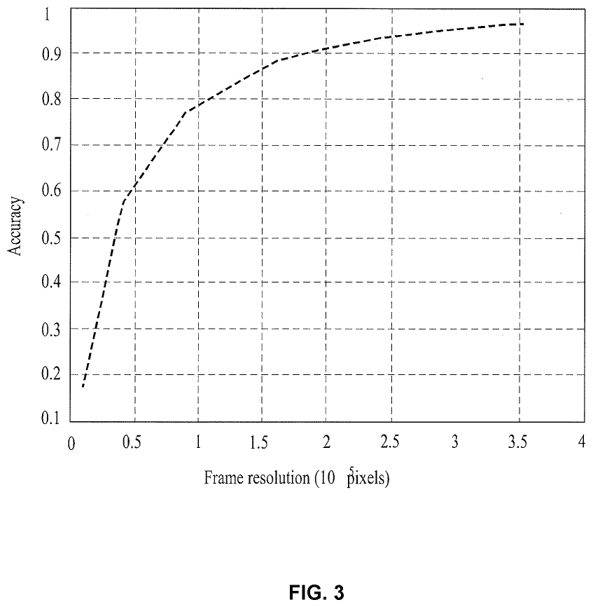

FIGS. 3, 4 and 5 are diagrams for illustrating operating characteristics of the communication system according to various embodiments.

According to various embodiments, an object recognition process for an image captured by the electronic device 110 may be offloaded onto the edge server 130. To this end, if the electronic device 110 transmits an image to the edge server 130, efficient energy consumption may be important. For this reason, resolution and transmission power of an image may be determined so that recognition accuracy for an object is secured to a given level and the amount of energy consumed by the electronic device 110 is minimized. In this case, the resolution of the image may be represented as the size of the image. In this case, the electronic device 110 may determine the resolution and transmission power of the image based on conditions C1, C2, C3, and C4, defined as in Equation 2, so that an object defined as in Equation 1 is achieved.

$${minimize}_{( s , p )} E - α A \qquad [ Equation 1 ]$$

In Equation 1, E may indicate the amount of energy consumed, A may indicate recognition accuracy for the object, and a may indicate an adjustment factor.

C1: A≥Aₘᵢₙ,

C2; L≤Lₘₐₓ,

C3: 0<p≤pₘₐₓ,

C4: 0<s≤sₘₐₓ [Equation 2]

In Equation 2, Aₘᵢₙ may indicate minimum recognition accuracy, L may indicate service delay, Lₘₐₓ may indicate a maximum service delay, p may indicate transmission power of an image to be transmitted, pₘₐₓ may indicate maximum transmission power, s may indicate resolution of an image to be transmitted, and sₘₐₓ may indicate maximum resolution, for example, resolution of an original image. For example, Aₘᵢₙ may be a constant.

According to Equation 1, the electronic device 110 may derive an optimal amount of energy consumed and optimal recognition accuracy by adjusting the adjustment factor (α) between the amount of energy consumed and recognition accuracy. For example, if the electronic device 110 is charged with sufficient power, the electronic device 110 may upward adjust the adjustment factor (α) in order to secure the highest recognition accuracy. For another example, if power charged into the electronic device 110 is not sufficient, the electronic device 110 may adjust the adjustment factor (α) downward, for example, to 0 in order to minimize the amount of energy consumed. In other words, the electronic device 110 may determine resolution and transmission power of an image so that the object of Equation 1 is achieved through the conditions C1 and C2 of the conditions of Equation 2.

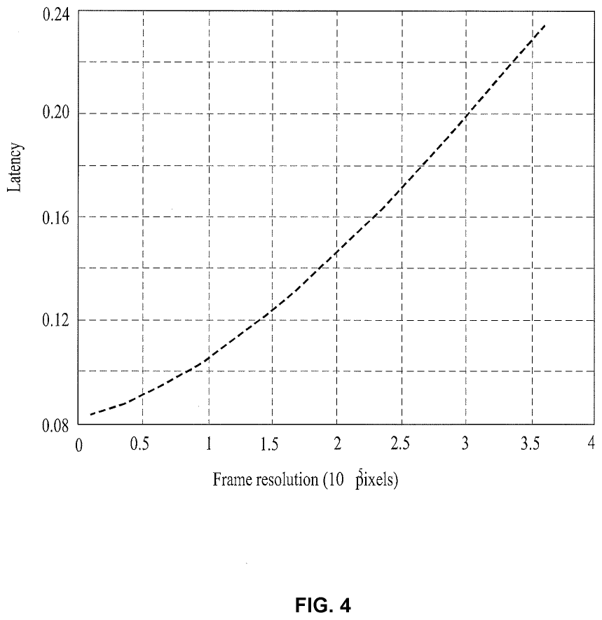

According to various embodiments, a concave relation may be established between resolution and recognition accuracy of an image, as shown in FIG. 3. This may indicate that a function A(s) indicative of recognition accuracy (A) according to resolution (s) of an image is concave with respect to the resolution (s) of the image. According to various embodiments, a convex relation, such as that shown in FIG. 4, may be established between resolution and service delay of an image. This may indicate that a function (L_{P}(s)) indicative of service delay (Lp) of an object recognition process according to resolution (s) of an image is convex with respect to the resolution (s) of the image.

According to various embodiments, the service delay (L, L(p,s)) may be determined as the sum (i.e., L(p,s)=L_{c}+Lₜ(p,s)+Lₚ(s)) of a compression delay (L_{c}) taken for the electronic device 110 to compress an image, a transmission delay (Lₜ, Lₜ(p,s)) taken for the electronic device 110 to transmit the image to the edge server 130, and a recognition delay (Lₚ(s)) taken for the edge server 130 to recognize an object from the image. The compression delay (L_{c}) may be determined based on maximum resolution (sₘₐₓ) and a compression velocity (V) for the image, and may not be related to transmission power (p) and resolution (s). The transmission delay (Lₜ, Lₜ(p,s)) may be determined based on a Shannon channel capacity (R(p)) according to a color information quantity (σ), resolution (s) and transmission power (p) per pixel (i.e., σs/R(p)). In this case, the Shannon channel capacity (R(p)) may be defined like Equation 3. As shown in FIG. 4, the recognition delay (Lₚ(s)) may be convex with respect to resolution (s). That is, the service delay (L, L(p,s)) is a function for transmission power (p) and resolution (s) and may be convex with respect to the resolution (s).

R(p)=W log₂(1+ph²/N) [Equation 3]

In Equation 3, W may indicate a frequency bandwidth, h may indicate an antenna gain, and N may indicate the amount of white noise.

According to various embodiments, as shown in FIG. 3, the function A(s) indicative of recognition accuracy (A) according to resolution (s) of an image may be concave with respect to the resolution (s) of the image. That is, such a function A(s) is an increasing function. Accordingly, in order satisfy the condition C1 of the conditions of Equation 2, resolution (s) of an image needs to be a threshold or more, that is, a preset resolution (sₘᵢₙ) or more. In this case, determined resolution (sₘᵢₙ) may be determined empirically or using a mathematical method in the electronic device 110. For example, if the function A(s) is modeled to 1−1.578e^{(-6.9×10-3√s)}, determined resolution (sₘᵢₙ) may be determined as

$${\{ - \frac{1000}{6.5} log ( \frac{1 \cdot {A}^{min}}{1.578} ) \}}^{2}$$

according to a mathematical method. For another example, determined resolution (sₘᵢₙ) may be determined empirically.

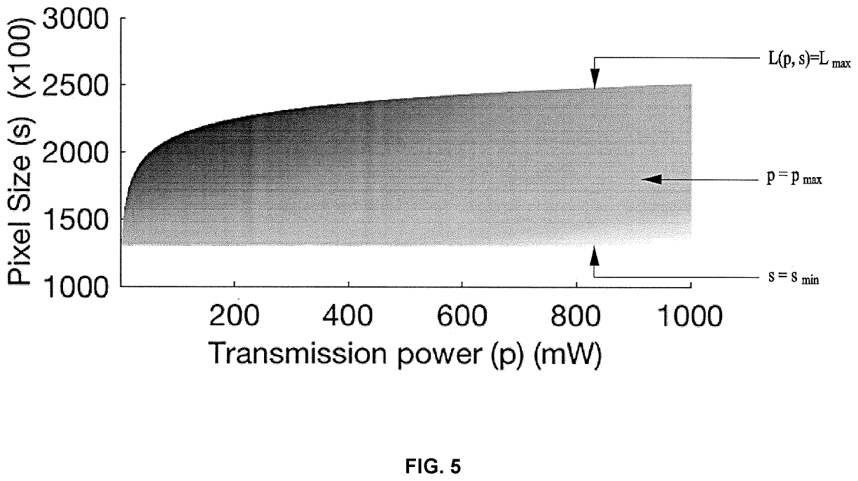

According to various embodiments, the condition C4 of the conditions of Equation 2 may be limited like Equation 4 depending on a characteristic of a function A(s) indicative of recognition accuracy (A) according to resolution (s) of an image. Furthermore, the range of transmission power (p) and resolution (s) may be limited based on the condition C2 of the conditions of Equation 2. To this end, as in Equation 5, a differential of a negative function may be calculated with respect to transmission power (p) and resolution (s) if service delay (L, L(p,s)) is the same as maximum service delay (Lₘₐₓ). According to Equation 5, if service delay (L, L(p,s)) is the same as maximum service delay (Lₘₐₓ), transmission power (p) and resolution (s) (if s>0 and p>0) may be present in the form of an increasing function, as shown in FIG. 5. Accordingly, the range of transmission power (p) and resolution (s) may be defined like Equation 6.

$$\begin{matrix} {s}_{min} < s \leq {s}_{max} & [ Equation 4 ] \\ L ( p , s ) = {L}_{c} + {L}_{t} ( p , s ) + {L}_{p} ( s ) = σ s \text{/} R ( p ) + {L}_{p} ( s ) + {L}_{c} = {L}_{max} , - \frac{σ {sR}^{′} ( p )}{{R ( p )}^{2}} + \frac{σ}{R ( p )} \frac{ds}{dp} + {L}_{p}^{′} ( s ) \frac{ds}{dp} = 0 , \frac{ds}{dp} = \{ \frac{R ( p )}{{L}_{p}^{′} ( s ) R ( p ) + σ} \} \frac{σ sR ′ ( p )}{{R ( p )}^{2}} = \{ \frac{1}{{L}_{p}^{′} ( s ) R ( p ) + σ} \} \frac{σ {sWh}^{2}}{R ( p ) log 2 ( N + {h}^{2} p )} & [ Equation 5 ]\end{matrix}$$

In Equation 5, Lₚ′(s) is a positive number within a range of s>0. Accordingly, if s>0 and p>0, ds/dp may be present in a positive range.

$$\{ ( p , s ) \vert \begin{matrix}L ( p , s ) \leq {L}_{max} ⋂ \\ {s}_{min} \leq s \leq {s}_{max} ⋂ \\ 0 \leq p \leq {p}_{max}\end{matrix} \} \qquad [ Equation 6 ]$$

According to various embodiments, if the range of transmission power (p) and resolution (s) is defined like Equation 6, an object function (U(p, s)) for minimizing the amount of energy consumed (E) of the electronic device 110 while securing recognition accuracy (A) for an object to a given level may be defined like Equation 7. In this case, the amount of energy consumed (E, E(p, s)) may be determined as the sum (i.e., E(p, s)=Eₜ(p, s)+E_{c}(s)) of transmission energy (Eₜ(p, s)) taken to transmit an image and compression energy (E_{c}(s)) taken to compress the image. The compression energy (E_{c}(s)) may be proportional to the amount of compressed data when resolution (s) is determined based on maximum resolution (sₘₐₓ) (i.e., E_{c}(s)∝σ(sₘₐₓ−s)). Accordingly, the compression energy (E_{c}(s)) may be represented like Equation 8. The transmission energy (Eₜ(p, s)) may be calculated like Equation 9 based on transmission power (p) and transmission delay (Lₜ, Lₜ(p,s)). Such an object function (U(p, s))) is an increasing function with respect to transmission power (p), as evidenced based on Equation 10, and may be concave with respect to the transmission power (p), as evidenced based on Equation 11.

U(p, s)=E(p, s)−αA(s) [Equation 9]

E_{c}=εσ(sₘₐₓ−s) [Equation 8]

In Equation 8, ε indicates a proportional factor, and may be obtained empirically or according to preset specifications in the electronic device 110.

$$\begin{matrix} {E}_{t} ( p , s ) = p \times {L}_{t} ( p , s ) = p σ s \text{/} R ( pa ) & [ Equation 9 ] \\ \frac{dU}{dp} = \frac{d}{dp} U ( p , s ) = \frac{d}{dp} \{ {E}_{c} ( s ) + {E}_{t} ( p , s ) - α A ( s ) \} = \frac{d}{dp} {E}_{t} ( p , s ) \\ \frac{d}{dp} {E}_{t} ( p , s ) = \frac{s σ log 2 \{ N log ( 1 + \frac{{ph}^{2}}{N} ) ( 1 + \frac{{ph}^{2}}{N} ) - {ph}^{2} \}}{NW {\{ log ( 1 + \frac{{ph}^{2}}{N} ) \}}^{2} ( 1 + \frac{{ph}^{2}}{N} )} & [ Equation 10 ]\end{matrix}$$

In Equation 10, 1+ph²/N is greater than 1 when p>0. Accordingly, dU/dp is always present when P>0, and is continuous and a positive number. As a result, U(p, s) may be an increasing function with respect to p.

$$\frac{{d}^{2} U}{{dp}^{2}} = \frac{{h}^{2} s σ log 2}{NW} \cdot \frac{2 \frac{{ph}^{2}}{N} - ( \frac{{ph}^{2}}{N} + 2 ) log ( 1 + \frac{{ph}^{2}}{N} )}{{\{ log ( 1 + \frac{{ph}^{2}}{N} ) \}}^{3} {( 1 + \frac{{ph}^{2}}{N} )}^{2}} \qquad [ Equation 11 ]$$

In Equation 11, assuming that

$$x = \frac{{ph}^{2}}{N} > 0 \& G ( x ) = 2 x - ( x + 2 ) log ( 1 + x ) , {lim}_{x \to 0} G ( x ) = 0 , and {G}^{′} ( x ) = \frac{x}{x + 1} - log ( 1 + x ) .$$

It may result in

$$\frac{x}{1 + x} < log ( 1 + x )$$

when x>−1, x≠0 depending on a characteristic of a log. Accordingly, it may result in G′(x)<0 when x>0. As a result, G(x) may be a decreasing function. It may result in G(x)<0 because

$${lim}_{x \to 0} G ( x ) = 0.$$

Accordingly, G(x) may be a negative number because

$$\frac{{d}^{2} U}{{dp}^{2}} = \frac{{h}^{2} s σ log 2}{NW} \cdot \frac{G ( x )}{{\{ log ( 1 + x ) \}}^{2} {( 1 + x )}^{2}} .$$

Accordingly, U(p, s) may be concave with respect to p.

According to various embodiments, an object function (U(p, s)) is an increasing function with respect to transmission power (p) and may be concave with respect to transmission power (p), within the range of the transmission power (p) and the resolution (s) defined like Equation 6. Accordingly, the electronic device 110 may determine a pair (p*, s*) of optimal transmission power (p*) and resolution (s*) that minimize an object function (U(p, s)), with respect to a pair (p, s) of given transmission power (p) and resolution (s) within the range of the transmission power (p) and resolution (s).

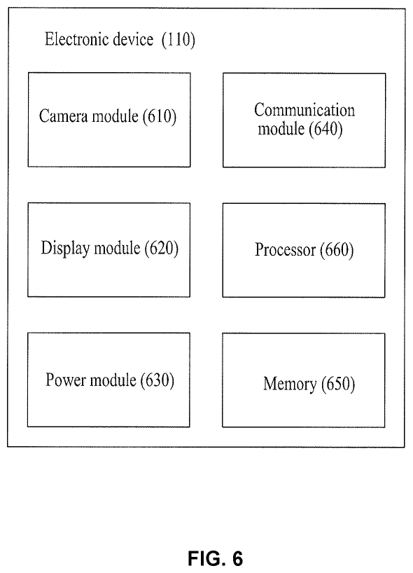

FIG. 6 is a diagram illustrating an electronic device 110 according to various embodiments.

Referring to FIG. 6, the electronic device 110 according to various embodiments may include at least any one of a camera module 610, a display module 620, a power module 630, a communication module 640, a memory 650 or a processor 660. In some embodiments, at least any one of the elements of the electronic device 110 may be omitted or one or more other elements may be added to the elements of the electronic device 110.

The camera module 610 may capture an image, that is, at least any one of a stop image or a moving image. For example, the camera module 610 may include at least any one of one or more lenses, image sensors, image signal processors or flashes.

The display module 620 may visually provide information of the electronic device 110. In this case, while the electronic device 110 is worn on a user's face, the display module 620 may be positioned ahead of the user's eye. For example, the display module 620 may include at least any one of a display, a hologram device or a projector and a control circuit for controlling at least any one of the same.

The power module 630 may supply power to at least any one of the elements of the electronic device 100. For example, the power module 630 may include a battery. The battery may include at least any one of a primary battery that cannot be recharged, a rechargeable secondary battery or a fuel cell, for example.

The communication module 640 may support communication for the electronic device 100 with an external apparatus (e.g., the BS 120 and the edge server 130). The communication module 640 may support at least any one of wired communication or wireless communication with the external apparatus. To this end, the communication module 640 may include at least any one of a wireless communication module or a wired communication module. For example, the wireless communication module may include at least any one of a cellular communication module, a short-distance wireless communication module or a satellite communication module.

The memory 650 may store various data used by at least any one of the elements of the electronic device 110. The data may include at least any one of at least one program and input data or output data related to the program, for example. For example, the memory 650 may include at least any one of a volatile memory or a non-volatile memory.

The processor 660 may control at least any one of the elements of the electronic device 110, and may perform various data processing or operations. To this end, the processor 660 may be connected to at least any one of the elements of the electronic device 100.

The processor 660 may determine optimal resolution (s*) and transmission power (p*) that satisfy maximum service delay (Lₘₐₓ) and minimum recognition accuracy (Aₘᵢₙ) necessary to recognize an object from an image (I). To this end, the processor 660 may calculate a plurality of candidate delays (L(p, s)) with respect to a plurality of candidate pairs (p, s) of a plurality of resolutions (s) and a plurality of transmission powers (p), respectively. Furthermore, the processor 660 may detect at least any one of candidate pairs (p, s) based on at least any one of candidate delays (L(p, s)) matched with maximum service delay (Lₘₐₓ). Accordingly, the processor 660 may determine optimal resolution (s*) and transmission power (p*) using the detected candidate pair (p, s). In this case, the processor 660 may determine the optimal resolution (s*) and transmission power (p*) using the detected candidate pair (p, s) so that the minimum recognition accuracy (Aₘᵢₙ) is satisfied and the amount of energy consumed (E(p, s)) necessary to transmit an image (I*) is minimized.

Accordingly, the processor 660 may adjust the image (I) based on the optimal resolution (s*). In this case, the processor 660 may generate the image (I*) having the optimal resolution (s*). Furthermore, the processor 660 may transmit the image (I*) based on the optimal transmission power (p*). The processor 660 may receive content related to the object from the edge server 130 through the communication module 640. The processor 660 may display the content related to the object on a background through the display module 620 in accordance with the reception.

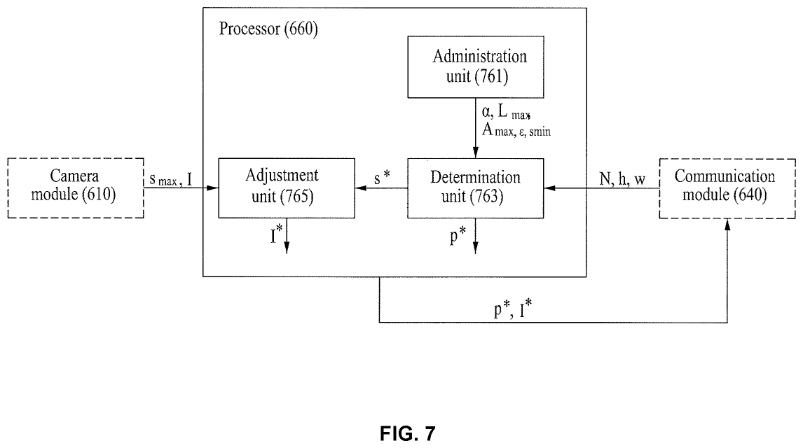

FIG. 7 is a diagram illustrating the processor 660 of FIG. 6.

Referring to FIG. 7, the processor 660 may include at least any one of an administration unit 761, a determination unit 763 or an adjustment unit 765.

The administration unit 761 may store and manage values for a plurality of parameters in order to manage quality of an object recognition process. In this case, the administration unit 761 may store and manage at least any one of maximum service delay (Lₘₐₓ), minimum recognition accuracy (Aₘₘ), minimum resolution (sₘᵢₙ), an adjustment factor (α) or a proportional factor (ε).

The determination unit 763 may determine optimal resolution (s*) and transmission power (p*). To this end, the determination unit 763 may check at least any one of maximum service delay (Lₘₐₓ), minimum recognition accuracy (Aₘᵢₙ), minimum resolution (sₘᵢₙ), an adjustment factor (α) or a proportional factor (ε) from the administration unit 761. Furthermore, the determination unit 763 may check at least any one of a frequency bandwidth (W), an antenna gain (h) or the amount of white noise (N) in accordance with a current communication environment from the communication module 640. The determination unit 763 may determine optimal resolution (s*) and transmission power (p*) based on at least any one of the frequency bandwidth (W), the antenna gain (h) or the amount of white noise (N).

The adjustment unit 765 may adjust an image (I), captured by the camera module 610, based on the optimal resolution (s*). Accordingly, the adjustment unit 765 may generate an image (I*) having the optimal resolution (s*).

Accordingly, the processor 660 may transmit the image (I*) based on the optimal transmission power (p*). The processor 660 may transmit the image (I*) to the edge server 130 through the communication module 640.

The electronic device 110 according to various embodiments may include the communication module 640 for wireless communication, the camera module 610 configured to capture an image, and the processor 660 connected to the communication module 610 and the camera module 640.

According to various embodiments, the processor 660 may be configured to determine resolution (s*) and transmission power (p*) that satisfy a maximum delay (Lₘₐₓ) and minimum recognition accuracy (Aₘᵢₙ) necessary to recognize an object from an image (I), adjust the captured image (I) based on the determined resolution (s*), and transmit an adjusted image (I*) based on the determined transmission power (p*), through the communication module 610.

According to various embodiments, the processor 660 may be configured to calculate a plurality of candidate delays (L(p, s)) with respect to a plurality of candidate pairs (p, s) of a plurality of resolutions (s) and a plurality of transmission powers (p), respectively, detect at least any one of the candidate pairs (p, s) based on at least any one of candidate delays matched with a maximum delay (Lₘₐₓ), and determine resolution (s*) and transmission power (p*) using the detected candidate pair (p, s).

According to various embodiments, the processor 660 may be configured to determine the resolution (s*) and transmission power (p*) from the detected candidate pair (p, s) so that the amount of energy consumed (E(p, s)) necessary to transmit the image (I*) is minimized while minimum recognition accuracy (Aₘᵢₙ) is satisfied.

According to various embodiments, the processor 660 may be configured to compress the adjusted image (I*) and to transmit the compressed image (I*) to the edge server 130 configured to recognize an object from the compressed image (I*) through the communication module 640.

According to various embodiments, a delay (L) may be determined as the sum of a compression delay (L_{c}) taken to compress an image, a transmission delay (Lₜ) taken to transmit the image to the edge server 130, and a recognition delay (Lₚ) taken for the edge server 130 to recognize an object from the image.

According to various embodiments, the amount of energy consumed (E) may be determined as the sum of transmission energy (Eₜ) taken to transmit an image and compression energy (E_{c}) taken to compress the image.

According to various embodiments, recognition accuracy (A) related to an adjusted image (I*) may be equal to or more than minimum recognition accuracy (Aₘᵢₙ). A delay (L) related to the adjusted image (I*) may be less than or equal to a maximum delay (Lₘₐₓ). Determined transmission power (p*) may exceed 0 and may be less than or equal to maximum transmission power that may be output by the electronic device 110. Determined resolution (s*) may exceed 0 and may be less than or equal to resolution (sₘₐₓ) of a captured image (I).

According to various embodiments, the determined resolution (s*) is more than preset resolution (sₘᵢₙ). The determined preset resolution (sₘᵢₙ) may be determined so that the recognition accuracy (A) related to the adjusted image (I*) is more than the minimum recognition accuracy (Aₘᵢₙ) or more.

According to various embodiments, the electronic device 110 may further include the display module 620 connected to the processor 660.

According to various embodiments, the processor 660 may be configured to receive content related to an object recognized from an image (I*) transmitted through the communication module 640, and to display the received content on a background through the display module 620.

According to various embodiments, the edge server 130 may be configured to receive an image (I*) transmitted from the electronic device 110, recognize an object from the received image (I*), and transmit content related to the object to the electronic device 110.

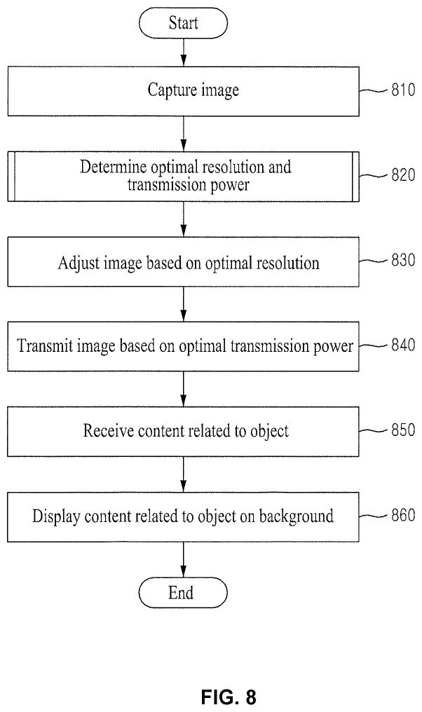

FIG. 8 is a diagram illustrating an operating method of the electronic device 110 according to various embodiments.

Referring to FIG. 8, at operation 810, the electronic device 110 may capture an image. The processor 660 may capture the image (I) through the camera module 610. In this case, the camera module 610 may output the image (I) having preset maximum resolution (sₘₐₓ).

At operation 820, the electronic device 110 may determine optimal resolution (s*) and transmission power (p*) for the image (I). The processor 660 may determine the optimal resolution (s*) and transmission power (p*) that satisfy maximum service delay (Lₘₐₓ) and minimum recognition accuracy (Aₘᵢₙ) necessary to recognize an object from the image (I). To this end, the processor 660 may calculate a plurality of candidate delays (L(p, s)) with respect to a plurality of candidate pairs (p, s) of a plurality of resolutions (s) and a plurality of transmission powers (p), respectively. Furthermore, the processor 660 may detect at least any one of the candidate pairs (p, s) based on at least any one of candidate delays (L(p, s)) matched with maximum service delay (Lₘₐₓ). Accordingly, the processor 660 may determine the optimal resolution (s*) and transmission power (p*) using the detected candidate pair (p, s). In this case, the processor 660 may determine the optimal resolution (s*) and transmission power (p*) using the detected candidate pair (p, s) so that the minimum recognition accuracy (Aₘᵢₙ) is satisfied and the amount of energy consumed (E(p, s)) necessary to transmit the image (I*) is minimized.

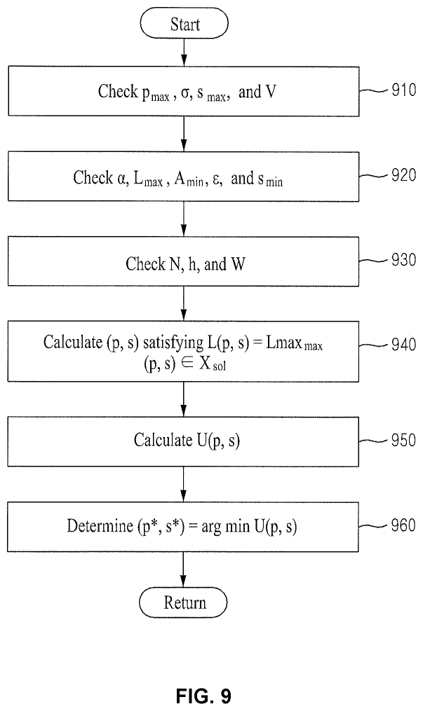

FIG. 9 is a detailed diagram illustrating the operation of determining resolution (s*) and transmission power (p*) in FIG. 8.

Referring to FIG. 9, at operation 910, the processor 660 may check maximum transmission power (pₘₐₓ), maximum resolution (sₘₐₓ), a compression velocity (V), and a color information quantity (σ) per pixel. Furthermore, at operation 920, the processor 660 may check at least any one of maximum service delay (Lₘₐₓ), minimum recognition accuracy (Aₘᵢₙ), minimum resolution (sₘᵢₙ), an adjustment factor (α) or a proportional factor (ε). In this case, the administration unit 761 may have stored at least any one of the maximum service delay (Lₘₐₓ), the minimum recognition accuracy (Aₘᵢₙ), the minimum resolution (sₘᵢₙ), the adjustment factor (α) or the proportional factor (ε). Furthermore, at operation 930, the processor 660 may check at least any one of a frequency bandwidth (W), an antenna gain (h) or the amount of white noise (N) in accordance with a current communication environment from the communication module 640.

At operation 940, the processor 660 may calculate at least any one of candidate pairs (p, s) based on at least any one of candidate delays (L(p, s)) matched with the maximum service delay (Lₘₐₓ) with respect to a plurality of candidate pairs (p, s) of a plurality of resolutions (s) and a plurality of transmission powers (p). The processor 660 may calculate the plurality of candidate delays (L(p, s)) with respect to the plurality of candidate pairs (p, s) of the plurality of resolutions (s) and the plurality of transmission powers (p), respectively, within the range of transmission power (p) and resolution (s) defined as in Equation 6. Thereafter, the processor 660 may detect at least any one of the candidate pairs (p, s) based on at least any one of the candidate delay (L(p, s)) matched with the maximum service delay (Lₘₐₓ). In this case, a set (Xₛₒₗ) of the detected candidate pair (p, s) may be defined.

At operation 950, the processor 660 may calculate an object function (U(p, s)) for the detected candidate pair (p, s). The object function (U(p, s)) may be defined for the purpose of minimizing the amount of energy consumed (E) by the electronic device 110 while securing recognition accuracy (A) for an object to a given level. In this case, the processor 660 may calculate the object function (U(p, s)) for the detected candidate pair (p, s) as in Equation 7. Thereafter, at operation 960, the processor 660 may determine the optimal resolution (s*) and transmission power (p*) based on the object function (U(p, s)). In this case, the processor 660 may determine the optimal resolution (s*) and transmission power (p*) to minimize the object function (U(p, s)) as in Equation 12. Thereafter, the processor 660 may return to the process of FIG. 8.

(p*, s*)=arg min U(p, s) [Equation 12]

Referring back to FIG. 8, at operation 830, the electronic device 110 may adjust the image (I) based on the optimal resolution (s*). The processor 660 may generate an image (I*) having the optimal resolution (s*). At this time, the processor 660 may compress the image (I*).

At operation 840, the electronic device 110 may transmit the image (I*) based on the optimal transmission power (p*). The processor 660 may transmit the image (I*) to the edge server 130 through the communication module 640. The communication module 640 may output the image (I*) using the optimal transmission power (p*).

At operation 850, the electronic device 110 may receive content related to an object in accordance with the image (I*). The processor 660 may receive the content related to the object from the edge server 130 through the communication module 640. To this end, the edge server 130 may receive the image (I*) from the electronic device 110 and recognize the object from the image (I*). Thereafter, the edge server 130 may transmit the content related to the object to the electronic device 110.

At operation 860, the electronic device 110 may display the content related to the object on a background. The processor 660 may display the content related to the object on the background through the display module 620. According to one embodiment, the background may be a reality background. For example, while the display module 620 passes through the reality background, the processor 660 may display the content related to the object through the display module 620. According to another embodiment, the background may be a background image. For example, the background image may be the captured image (I) at operation 810. The processor 660 may overlap and display the content related to the object on the image (I) while displaying the image (I) through the display module 620.

An operating method of the electronic device 110 according to various embodiments may include: capturing an image (I), determining resolution (s*) and transmission power (p*) that satisfy a maximum delay (Lₘₐₓ) and minimum recognition accuracy (Aₘᵢₙ) necessary to recognize an object from the image (I), adjusting the captured image (I) based on the determined resolution (s*), and transmitting an adjusted image (I*) based on the determined transmission power (p*).

According to various embodiments, the determining of the resolution (s*) and the transmission power (p*) may include calculating a plurality of candidate delays (L(p, s)) with respect to a plurality of candidate pairs (p, s) of a plurality of resolutions (s) and a plurality of transmission powers (p), respectively, detecting at least any one of the candidate pairs (p, s) based on at least any one of candidate delays (L(p, s)) matched with the maximum delay (Lₘₐₓ), and determining the optimal resolution (s*) and transmission power (p*) using the detected candidate pair (p, s).

According to various embodiments, the determining of the resolution (s*) and the transmission power (p*) may include determining the resolution (s*) and transmission power (p*) from the detected candidate pair (p, s) so that the amount of energy consumed (E) necessary to transmit the image (I*) is minimized while the minimum recognition accuracy (Aₘᵢₙ) is satisfied.

According to various embodiments, the transmitting of the adjusted image (I*) may include compressing the adjusted image (I*) and transmitting the compressed image (I*) to the edge server 130 configured to recognize an object from the compressed image (I*).

According to various embodiments, the delay (L) may be determined as the sum of a compression delay (L_{c}) taken to compress an image, a transmission delay (Lₜ) taken to transmit the image to the edge server 130, and a recognition delay (Lₚ) taken for the edge server 130 to recognize an object from the image.

According to various embodiments, the amount of energy consumed (E) may be determined as the sum of transmission energy (Eₜ) taken to transmit an image and compression energy (E_{c}) taken to compress the image.

According to various embodiments, recognition accuracy (A) related to the adjusted image (I*) may be equal to or more than minimum recognition accuracy (Aₘᵢₙ). The delay (L) related to the adjusted image (I*) may be less than or equal to a maximum delay (Lₘₐₓ). The determined transmission power (p*) may exceed 0 and may be less than or equal to maximum transmission power that may be output by the electronic device 110. The determined resolution (s*) may exceed 0 and may be less than or equal to resolution (sₘₐₓ) of the captured image (I).

According to various embodiments, the determined resolution (s*) may be more than preset resolution (sₘᵢₙ). The determined resolution (sₘᵢₙ) may be more than determined so that the recognition accuracy (A) related to the adjusted image (I*) is more than the minimum recognition accuracy (Aₘᵢₙ) or more.

According to various embodiments, an operating method of the electronic device 110 may further include receiving content related to an object recognized from the transmitted image (I*) and displaying the receive content on a background.

According to various embodiments, the edge server 130 may be configured to receive an image (I*) transmitted from the electronic device 110, recognize an object from the received image (I*), and transmit content related to the object to the electronic device 110.

According to various embodiments, the amount of energy consumed (E) by the electronic device 110 can be reduced because a process for recognizing an object from an image (I*) is offloaded onto the edge server 130. Furthermore, the electronic device 110 can secure recognition accuracy (A) for an object while minimizing a delay L according to the progress of a process. To this end, the electronic device 110 may determine resolution (s*) and transmission power (p*) of the image (I*) to be provided to the edge server 130 so that the recognition accuracy (A) for the object is secured to a given level and the amount of energy consumed (E) by the electronic device 110 is minimized. Accordingly, the amount of energy consumed (E) by the electronic device 110 can be minimized. That is, the electronic device 110 can implement the minimization of the amount of energy consumed (E) by taking into consideration a delay (L), recognition accuracy (A) and resolution (s*).

The embodiments of this document and the terms used in the embodiments are not intended to limit the technology described in this document to a specific embodiment, but should be construed as including various changes, equivalents and/or alternatives of a corresponding embodiment. Regarding the description of the drawings, similar reference numerals may be used in similar elements. An expression of the singular number may include an expression of the plural number unless clearly defined otherwise in the context. In this document, an expression, such as “A or B”, “at least one of A or/and B”, “A, B or C” or “at least one of A, B and/or C”, may include all of possible combinations of listed items together. Expressions, such as “a first,” “a second,” “the first” and “the second”, may modify corresponding elements regardless of the sequence and/or importance, and are used to only distinguish one element from the other element and do not limit corresponding elements. When it is described that one (e.g., first) element is “(operatively or communicatively) connected to” or “coupled with” the other (e.g., second) element, one element may be directly connected to the other element or may be connected to the other element through another element (e.g., third element).

The “module” used in this document includes a unit configured with hardware, software or firmware, and may be interchangeably used with a term, such as logic, a logical block, a part or a circuit. The module may be an integrated part, a minimum unit to perform one or more functions, or a part thereof. For example, the module may be configured with an application-specific integrated circuit (ASIC).

Various embodiments of this document may be implemented as software including one or more commands stored in a storage medium (e.g., the memory 650) readable by a machine (e.g., the electronic device 110). For example, the processor (e.g., the processor 660) of the machine may fetch at least one of one or more stored commands from the storage medium, and may execute the command. This enables the machine to execute at least one function based on the fetched at least one command. The one or more commands may include code generated by a compiler or code executable by an interpreter. The storage medium readable by the machine may be provided in the form of a non-transitory storage medium. In this case, “non-transitory” means that the storage medium is a tangible device and does not include a signal (e.g., electromagnetic waves), and is not limited to whether data is stored in the storage media semi-permanently or temporally.

According to various embodiments, each of elements (e.g., module or program) may include a single entity or a plurality of entities. According to various embodiments, one or more of the above-described elements or operations may be omitted or one or more other elements or operations may be added. Alternatively or additionally, a plurality of elements (e.g., modules or programs) may be integrated into a single element. In such a case, the integrated element may perform one or more functions of each of the plurality of elements identically or similarly to a function performed by a corresponding element of the plurality of elements before they are integrated. According to various embodiments, operations performed by a module, a program or other elements may be executed sequentially, in parallel, repeatedly, or heuristically, or one or more of the operations may be executed in different order or may be omitted, or one or more operations may be added.

According to various embodiments, the amount of energy consumed by the electronic device can be reduced because a process for recognizing an object from an image is offloaded onto the edge server. Furthermore, the electronic device can secure recognition accuracy for an object while minimizing a delay according to the progress of a process. To this end, the electronic device may determine resolution and transmission power of the image to be provided to the edge server so that the recognition accuracy for the object is secured to a given level and the amount of energy consumed by the electronic device is minimized. Accordingly, the amount of energy consumed by the electronic device can be minimized. That is, the electronic device can implement the minimization of the amount of energy consumed by taking into consideration a delay, recognition accuracy and resolution.

What is claimed is:

1. An operating method of an electronic device, comprising:
capturing an image;
determining a resolution and a transmission power satisfying a maximum delay and minimum recognition accuracy necessary to recognize an object from the image;
adjusting the captured image based on the determined resolution; and
transmitting the adjusted image based on the determined transmission power.

2. The method of claim 1, wherein the determining of the resolution and the transmission power comprises:
calculating a plurality of candidate delays with respect to a plurality of candidate pairs of a plurality of resolutions and a plurality of transmission powers, respectively;
detecting at least any one of the candidate pairs based on at least any one of candidate delays matched with the maximum delay; and
determining the resolution and the transmission power using the detected candidate pair.

3. The method of claim 2, wherein the determining of the resolution and the transmission power comprises:
determining the resolution and the transmission power from the detected candidate pair so that an amount of energy consumed to transmit the image is minimized while the minimum recognition accuracy is satisfied.

4. The method of claim 2, wherein the transmitting of the adjusted image comprises:
compressing the adjusted image; and
transmitting the compressed image to an edge server configured to recognize the compressed image from the object.

5. The method of claim 4, wherein the delay is determined as a sum of a compression delay taken to compress the image, a transmission delay taken to transmit the image to the edge server, and a recognition delay taken for the edge server to recognize the object from the image.

6. The method of claim 3, wherein the amount of energy consumed is determined as a sum of transmission energy taken to transmit the image and compression energy taken to compress the image.

7. The method of claim 1, wherein:
a recognition accuracy related to the adjusted image is equal to or more than the minimum recognition accuracy,
a delay related to the adjusted image is less than or equal to the maximum delay,
the determined transmission power exceeds 0 and is less than or equal to a maximum transmission power capable of being output by the electronic device, and
the determined resolution exceeds 0 and is less than or equal to a resolution of the captured image.

8. The method of claim 7, wherein:
the determined resolution is more than a preset resolution, and
the determined resolution is determined so that the recognition accuracy related to the adjusted image is more than the minimum recognition accuracy.

9. The method of claim 1, further comprising:
receiving content related to an object recognized from the transmitted image; and
displaying the received data on a background.

10. The method of claim 9, wherein an edge server is configured to:
receive the image transmitted from the electronic device,
recognize an object from the received image, and
transmit the content related to the recognized object to the electronic device.

11. An electronic device, comprising:
a communication module for wireless communication;
a camera module configured to capture an image; and
a processor connected to the communication module and the camera module,
wherein the processor is configured to:
capture an image,
determine a resolution and a transmission power satisfying a maximum delay and minimum recognition accuracy necessary to recognize an object from the image,
adjust the captured image based on the determined resolution, and
transmit the adjusted image based on the determined transmission power through the communication module.

12. The electronic device of claim 11, wherein the processor is configured to:
calculate a plurality of candidate delays with respect to a plurality of candidate pairs of a plurality of resolutions and a plurality of transmission powers, respectively,
detect at least any one of the candidate pairs based on at least any one of candidate delays matched with the maximum delay, and
determine the resolution and the transmission power using the detected candidate pair.

13. The electronic device of claim 12, wherein the processor is configured to:
determine the resolution and the transmission power from the detected candidate pair so that an amount of energy consumed to transmit the image is minimized while the minimum recognition accuracy is satisfied.

14. The electronic device of claim 12, wherein the processor is configured to:
compress the adjusted image, and
transmit the compressed image to an edge server configured to recognize the compressed image from the object through the communication module.

15. The electronic device of claim 14, wherein the delay is determined as a sum of a compression delay taken to compress the image, a transmission delay taken to transmit the image to the edge server, and a recognition delay taken for the edge server to recognize the object from the image.

16. The electronic device of claim 13, wherein the amount of energy consumed is determined as a sum of transmission energy taken to transmit the image and compression energy taken to compress the image.

17. The electronic device of claim 11, wherein:
a recognition accuracy related to the adjusted image is equal to or more than the minimum recognition accuracy,
a delay related to the adjusted image is less than or equal to the maximum delay,
the determined transmission power exceeds 0 and is less than or equal to a maximum transmission power capable of being output by the electronic device, and
the determined resolution exceeds 0 and is less than or equal to a resolution of the captured image.

18. The electronic device of claim 17, wherein:
the determined resolution is more than a preset resolution, and
the determined resolution is determined so that the recognition accuracy related to the adjusted image is more than the minimum recognition accuracy.

19. The electronic device of claim 11, further comprising a display module connected to the processor,
wherein the processor is configured to:
receive content related to an object recognized from the transmitted image through the communication module, and
display the received data on a background.

20. The electronic device of claim 19, wherein an edge server is configured to:
receive the image transmitted from the electronic device,
recognize an object from the received image, and
transmit the content related to the recognized object to the electronic device.
